(19) United States
(12) Patent Application Publication
(10) Pub. No.: US 2026/0089566 A1
(43) Pub. Date: Mar. 26, 2026

(54) MEDIUM ACCESS CONTROL ADDRESS-BASED TRAFFIC ISOLATION FOR WIRELESS ACCESS POINTS

(71) Applicant: AT&T Intellectual Property I, L.P., Atlanta, GA (US)

(72) Inventors: Ronak Arunkumar Shah, Issaquah, WA (US); Arnold Schrider, Mercer Island, WA (US)

(21) Appl. No.: 18/895,364

(22) Filed: Sep. 24, 2024

(51) Int. Cl. H04W 28/10; H04L 45/745; H04L 47/2425; H04L 61/2596

(52) U.S. Cl. CPC H04W 28/10; H04L 45/745; H04L 47/2433; H04L 61/2596

(57) ABSTRACT

A processing system of a wireless access point may receive a first frame from an endpoint device, the first frame including a first medium access control address of the endpoint device, determine that the first medium access control address is a medium access control address designated for a differentiated data traffic processing via the processing system, and isolate the first frame for processing via the wireless access point, wherein the isolating segregates, within the wireless access point, the first frame from at least a second frame including at least a second medium access control address that is not designated for the differentiated data traffic processing via the processing system.

The present disclosure relates to networking equipment, such as wireless access points, and more particularly describes apparatuses, non-transitory computer-readable media, and methods for isolating a first frame for processing via a wireless access point in response to determining that a first medium access control address of the first frame is a medium access control address for differentiated data traffic processing. The present disclosure also describes apparatuses, non-transitory computer-readable media, and methods for transmitting a first frame comprising at least a portion of a payload of a packet that is received from a network address translation module in accordance with a first medium access control address that is identified in the payload of the packet.

### BACKGROUND

Wireless access points (e.g., Wi-Fi access points (APs)) typically provide a medium access control (MAC)-based access filtering (layer 2 (L2)). This allows the wireless access point to decide whether a client, or endpoint device, identified using the client's MAC address, is allowed service from the wireless access point. In particular, MAC address-based filtering controls which clients (e.g., pre-defined clients) can access (or are blocked from) the services/functions provided by the wireless access point. However, once the access is granted, all traffic flows may be processed based on existing/pre-defined rules.

### SUMMARY

In one example, the present disclosure discloses an apparatus, non-transitory computer readable medium, and method for isolating a first frame for processing via a wireless access point in response to determining that a first medium access control address of the first frame is a medium access control address for differentiated data traffic processing. For example, a processing system of a wireless access point including at least one processor may receive a first frame from an endpoint device, the first frame including a first medium access control address of the endpoint device, determine that the first medium access control address is a medium access control address designated for a differentiated data traffic processing via the processing system, and isolate the first frame for processing via the wireless access point, wherein the isolating segregates, within the wireless access point, the first frame from at least a second frame including at least a second medium access control address that is not designated for the differentiated data traffic processing via the processing system.

In one example, the present disclosure also discloses an apparatus, non-transitory computer readable medium, and method for transmitting a first frame comprising at least a portion of a payload of a packet that is received from a network address translation module in accordance with a first medium access control address that is identified in the payload of the packet. For example, a processing system of a wireless access point including at least one processor may receive a first packet from the NAT module, identify a first medium access control address designated for a differentiated data traffic processing via the processing system in an options field of a header of the first packet or in a payload of the first packet, and transmit to a first endpoint device via the MAC filter module and the radio unit, a first frame comprising at least a portion of the payload in accordance with the first MAC address that is identified.

### BRIEF DESCRIPTION OF THE DRAWINGS

The teaching of the present disclosure can be readily understood by considering the following detailed description in conjunction with the accompanying drawings, in which:

FIG. 1 illustrates an example wireless access point with a medium access control traffic prioritization module, in accordance with the present disclosure;

FIG. 2 illustrates a flowchart of an example method for isolating a first frame for processing via a wireless access point in response to determining that a first medium access control address of the first frame is a medium access control address for differentiated data traffic processing;

FIG. 3 illustrates a flowchart of an example method for transmitting a first frame comprising at least a portion of a payload of a packet that is received from a network address translation module in accordance with a first medium access control address that is identified in the payload of the packet; and

FIG. 4 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

Wireless access points (e.g., Wi-Fi access points (APs)) typically provide a medium access control (MAC)-based access filtering (e.g., at layer 2 (L2)). This allows the wireless access point to decide whether a client, or endpoint device, identified using the client's MAC address, is allowed service from the wireless access point. In particular, MAC address-based filtering controls which clients (e.g., pre-defined clients) can access (or are blocked from) the services/functions provided by the wireless access point. However, once the access is granted, all traffic flows may be processed based on existing/pre-defined rules. Although the MAC address of a device is known to the wireless access point, this information is generally used for access control only. For example, the combined data traffic from various clients is routed using routing functions within the wireless access point using layer 3 (L3) protocols. This implementation promotes privacy and avoids MAC address disclosure at layer 3.

Examples of the present disclosure extend the utilization of MAC addresses to provide differentiated processing via a wireless access point for one or more specific MAC addresses, while maintaining the privacy and security of existing implementations. To further illustrate, data traffic for a specific endpoint device may be routed to a designated layer 3 destination using a bi-directional layer 2 to layer 3 mapping, while allowing data traffic from other endpoint devices to be routed without such differentiation or other modification. As such, isolated MAC data traffic can be prioritized efficiently for applications where it may be desirable for data traffic from one or more endpoint devices to be prioritized over data traffic from other endpoint devices within the same wireless (e.g., Wi-Fi) access network.

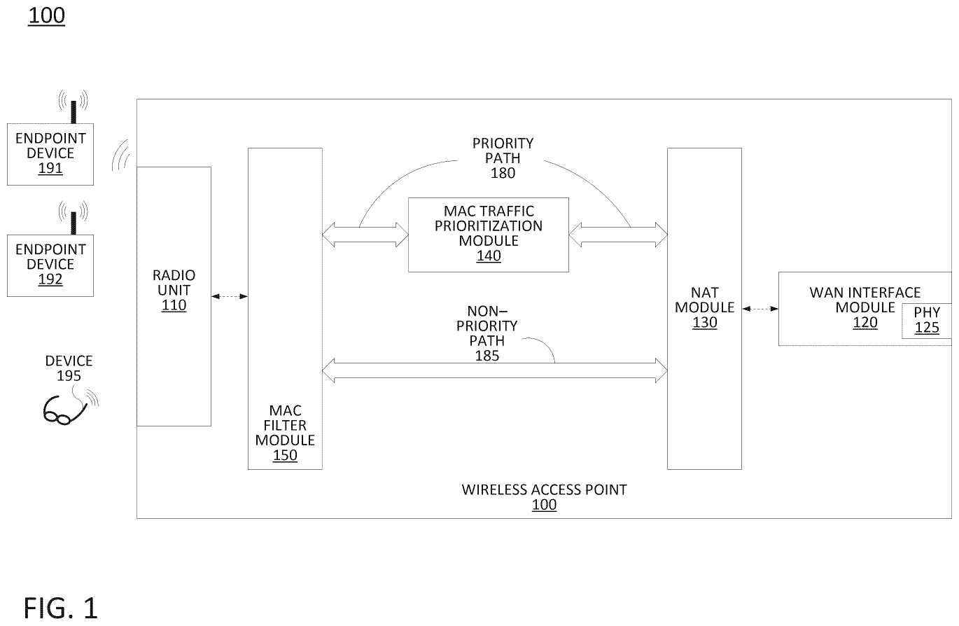

For example, upon reception of data frames from an endpoint device with a specific MAC address, a wireless access point of the present disclosure may isolate the data traffic and update a destination address to a new destination. The forwarding of all frames from a specific MAC may ensure that all data from an endpoint device in the network that matches the MAC is isolated and can be routed within the wireless access point separate from data traffic for other endpoint devices. For example, a purpose-built wireless access point for augmented reality (AR), virtual reality (VR), or the like may isolate, prioritize, and manage AR/VR data traffic separate from traffic from other clients on the same wireless network. In one example, a wireless access point of the present disclosure with a MAC traffic prioritization module may also provide a network operator with the ability to bridge/map 5G user equipment (UE) route selection policy (URSP) rules onto non-cellular devices (e.g., Wi-Fi-only device support). These and other aspects of the present disclosure are discussed in greater detail below in connection with the examples of FIGS. 1-4.

To aid in understanding the present disclosure, FIG. 1 illustrates an example wireless access point 100, e.g., an apparatus, in accordance with the present disclosure. In particular, the wireless access point 100 may include a radio unit 110, e.g., a radio, antenna(s)/antenna array(s), etc., e.g., in accordance with Institute of Electrical and Electronics Engineers (IEEE) 802.11 (Wi-Fi), or the like. The radio unit 110 may comprise a physical layer (layer 1) interface for wireless communication with endpoint devices 191, 192, 195, and so forth. In one example, the radio unit 110 may transmit and receive data as layer 2 Wi-Fi frames. To illustrate, a Wi-Fi frame may include source and destination MAC addresses, which may comprise a MAC address of one of endpoint devices 191, 192, or 195, and a MAC address of wireless access point 100 (and/or of radio unit 110 thereof). A Wi-Fi frame may also include a quality of service (QoS)/class of service (Cos) or traffic type indicator, and may encapsulate a layer 3 packet, e.g., an Internet Protocol (IP) packet. For example, the IP packet may include a source IP address and a destination IP address (as well as a source port, destination port, etc.).

Wireless access point 100 may further include a wide area network (WAN) interface module 120, which may include a physical transceiver, or PHY 125. For example, the WAN interface module 120 may comprise or may be referred to as a network adapter module, port interface modules (PIM), line card, or the like. To further illustrate, in one example the WAN interface module 120 may comprise: a small form-factor pluggable (SFP) module, an enhanced SFP module (SFP+), a gigabit Ethernet SFP (GE-SFP) module, a power-over-Ethernet (PoE) SFP module, and so forth. In one example, the WAN interface module 120 and/or PHY 125 may transmit and receive frames, e.g., Ethernet frames, to and from one or more provider edge (PE) routers or the like (e.g., ingress/egress points of a communication service provider network). In one example, the WAN interface module 120 and/or PHY 125 may be coupled to a gateway, which in turn may be connected to one or more PE routers. The frames received and transmitted by WAN interface module 120 and/or PHY 125 may comprise Ethernet frames that encapsulate IP packets.

As further illustrated in FIG. 1, the wireless access point 100 may include a medium access control (MAC) filter module 150, which may perform access control based on MAC addresses for endpoint devices seeking to connect to the wireless network associated with the wireless access point 100. For instance, wireless access point 100 may advertise/broadcast a wireless network identified by service set identifier (SSID). Endpoint devices seeking to attach to the wireless network may then initiate registration with the wireless access point 100 using the SSID (and other parameters advertised, such as the encryption type, frequency bands(s) and/or channel(s), etc.). For instance, endpoint device 191 may transmit a registration message which may contain a MAC address of endpoint device 191, a password, and so forth. In addition to wireless access point 100 verifying the correct password is provided, wireless access point 100 may apply MAC filtering via MAC filter module 150. For example, the MAC filter module 150 may apply a set of one or more rules, which may include a list of one or more MAC addresses to block (e.g., to disallow from connecting to/receiving service from the wireless access point 100) and/or a list of one or more MAC addresses to permit access, conditional rules, such as to block (or allow) one or more MAC addresses at certain times, days of the week, etc., to block one or more MAC addresses in times of congestion or when a threshold number of other endpoint devices are already on the wireless network (e.g., connected to wireless access point 100), and so forth. MAC filter module 150 may similarly apply such rules to endpoint devices 192 and 195 at times when such devices may seek to register. In one example, MAC filter module 150 may continue to apply MAC filtering rules to incoming and outgoing data traffic such that when conditions change that may trigger a rule, an endpoint device that is previously granted access to the wireless network may later be blocked, even in the middle of a stream of packets/frames for the endpoint device. In addition, rules may be modified or added that may change the ultimate action of MAC filter module 150 to either permit or deny registration and/or pending data traffic for various endpoint devices.

In addition, wireless access point 100 may include a network address translation (NAT) module 130, which may translate internal IP addresses valid within the wireless network of wireless access point 100 to external IP addresses that may be used to communicate with other devices or systems external to the wireless network. To illustrate, upon registration with wireless access point 100, endpoint device 191 may be assigned a local IP address, e.g., from a designated range that is available for assignment as a local IP address. For an outgoing packet from endpoint device 191, NAT module 130 may substitute (e.g., translate) the local IP address with a public IP address, and may include a designated port number, where the public IP address and port number together indicate to external entities a particular source of the packet (e.g., endpoint device 191). Similarly, an external entity may address a packet to endpoint device 191 by indicating the public IP address and designated port number as the destination IP address and destination port number, respectively. Upon receiving such a packet from WAN interface module 120, NAT module 130 may refer to a table or other mapping of the public IP address and port number to local IP address. NAT module 130 may then substitute the public IP address with the local IP address. The port number may or may not be modified in various examples, e.g., based upon the configuration of NAT module 130, or the configuration of the wireless network provided by wireless access point 100.

Continuing with the present example, a local IP address may be assigned to endpoint device 191. NAT module 130 may then forward an inbound packet toward endpoint device 191 (in some cases with port modification). In one example, the forwarding may be via non-priority path 185, described in greater detail below. It should also be noted that the inbound packet may be received at NAT module 130 from WAN interface module 120 as part of a layer 2 (L2) frame. In addition, the NAT module 130 may forward the packet with modified IP address to MAC filter module 150 as an L2 frame. In one example, a destination MAC address may be changed to a MAC address of endpoint device 191 for transmission over-the-air via radio unit 110. In addition, the source MAC address may be updated to a MAC address of radio unit 110. In one example, MAC filter module 150 may further scan the source and/or destination MAC addresses to determine whether one or more rules are triggered that would indicate to block (or allow) the inbound packet.

In accordance with the present disclosure, wireless access point 100 may further include a MAC traffic prioritization module 140 which may provide access to a priority path 180 through wireless access point for one or more designated MAC addresses (e.g., for one or more particular endpoint devices designated to receive MAC address-based differentiated service via wireless access point 100). In one example, MAC traffic prioritization module 140 may comprise a hardware element, e.g., an application specific integrated circuit (ASIC), a programmable gate array (PGA), such as a field-programmable gate array (FPFA), and/or a dedicated set of code, instructions, variables, etc. loaded into memory and executed by one or more hardware processors as running processes to isolate traffic for the one or more selected MAC addresses. In one example, wireless access point 100 may offer network access to endpoint devices 191 and 192 (e.g., general-purpose clients) and to endpoint device 195 (e.g., a differentiated-service client, such as an AR/VR headset or the like). The MAC filter module 150 may first filter the endpoint devices by MAC address, and assuming that all are granted service, frames from endpoint device 195 may be directed to MAC traffic prioritization module 140 that is capable of isolating and transmitting/receiving data traffic for endpoint device 195 through the NAT module 130 and priority path 180. Data traffic for endpoint device 195 may remain isolated in the wireless access point 100, e.g., separate from data traffic to/from general-purpose clients (e.g., endpoint devices 191 and 192) via non-priority path 185. To further illustrate, MAC traffic prioritization module 140 may isolate data traffic for one or more selected MAC addresses while using a shared NAT module 130 and WAN interface module 120 for communicate outside of the wireless access network of wireless access point 100.

In one example, a network operator (e.g., of a wide-area network (WAN) may sell or otherwise distribute the wireless access point 100 and the endpoint device 195 to a user or customer entity, e.g., as a package deal or otherwise. In one example, the MAC address of endpoint device 195 and the public IP address of the wireless access point 100 (e.g., assigned to the WAN interface module 120) may be known to the WAN operator. Accordingly, the WAN operator may seek to address data traffic to endpoint device 195 to deliver content. While the WAN operator may know the MAC address of the endpoint device 195 and may know the IP address of the WAN interface module 120, it does not know a designated port to reach the endpoint device 195 via NAT, nor does the WAN operator know the internal/private IP address of the endpoint device 195. However, in accordance with the present disclosure, MAC traffic prioritization module 140 may be assigned its own internal IP address. In addition, a public IP address and port number associated with MAC traffic prioritization module 140 may be shared with the WAN operator. As such, the WAN operator may direct packets to the MAC traffic prioritization module 140. In accordance with the present disclosure, a payload of an IP packet or an options field of the IP header may be used to convey the MAC address of an intended destination endpoint device. In addition, the MAC traffic prioritization module 140 may be configured to extract the embedded MAC address.

In one example, the MAC traffic prioritization module 140 may first identify that the MAC address is a MAC address that is designated for differentiated processing via the wireless access point 100. For instance, in one example, the wireless access point 100 may be configured to work with one or a few endpoint devices. As such, allowed endpoint device MAC addresses could be included in a programmable read-only memory of the MAC traffic prioritization module 140, or the like. For example, the wireless access point 100 and the authorized endpoint devices may be distributed as a fixed or relatively fixed pair or set. Alternatively, or in addition, the MAC traffic prioritization module 140 may include a storage component to store a list of authorized MAC addresses, which may change from time to time. For instance, an owner of the wireless access point 100 and/or a WAN operator may update a list of authorized MAC address which may receive differentiated processing via the wireless access point. In one example, the MAC traffic prioritization module 140 may direct at least a portion of the inbound packet to endpoint device 195 via priority path 180. This may include encapsulating the packet in an L2 frame that includes the MAC address of endpoint device 195 as the destination MAC address. In one example, extraneous packet/frame processing that may be applied to other packets via non-priority path 185 may be avoided via priority path 180. In one example, data traffic from both priority path 180 and non-priority path 185 may be minimally processed via MAC filtering module 150, e.g., to verify that traffic is allowed over the wireless network for the MAC addresses of the respective endpoint devices.

In one example, the NAT module 130 may be unaware that the endpoint device 195 exists or is behind the MAC traffic prioritization module 140. However, in another example, endpoint device 195 may also be assigned an IP address that may be used for non-priority traffic of the endpoint device 195. Nevertheless, with respect to inbound data traffic addressed to the IP address of the MAC traffic prioritization module 140, the NAT module 130 remains unaware of the ultimate destination, e.g., endpoint device 195. As such, the functionality of the NAT module 130 may be unmodified to support the new functionality of the MAC traffic prioritization module 140.

In an illustrative example, endpoint device 195 may establish a radio connection with the wireless access point 100, e.g., according to IEEE 802.11/Wi-Fi registration procedures. In one example, endpoint device 195 may send its MAC address as part of the registration process. In accordance with the present disclosure, all new registrations may be screened via MAC traffic prioritization module 140. Accordingly, when the registration passes the MAC filtering module 150, the MAC address of endpoint device 195 may be received by the MAC traffic prioritization module 140, which may then decide whether it will handle traffic for the endpoint device 195. In one example, a list of MAC addresses for devices that may be paired with the MAC traffic prioritization module 140 may be hard-coded into the MAC traffic prioritization module 140, e.g., by a vendor, a network operator, or the like, prior to dispatch to a customer premises. Alternatively, or in addition, a WAN operator and/or an owner of the wireless access point 100 may direct over-the-air (OTA) instructions to the MAC traffic prioritization module 140 to provision a list of one or more allowed endpoint devices (e.g., allowed MAC addresses). In one example, the instructions may include a duration of validity or other parameters.

In one example, the MAC traffic prioritization module 140 may provide a basic list to MAC filter module 150 of outbound packets/frames to divert to MAC traffic prioritization module, e.g., based upon only the source MAC address in the frame header. Data traffic for endpoint devices with MAC addresses not in the list (such as endpoint devices 191 and 192) may receive non-priority processing via non-priority path 185. However, for endpoint device 195, the MAC address may be in the list. As such, MAC traffic prioritization module 140 may begin mirroring for endpoint device 195. For instance, if endpoint device 195 attempts to initiate communication to a remote server via the WAN, a packet from endpoint device 195 may be received via radio unit 110 and directed to MAC traffic prioritization module 140. Accordingly, data traffic for endpoint device 195 is isolated, or segregated from data traffic for endpoint devices 191, 192, etc. within the wireless access point 100. Differentiated processing may then be provided to frames and/or packets for endpoint device 195. For instance, outgoing packets for endpoint device 195 may be directed via MAC traffic prioritization module 140, which may embed the MAC address of endpoint device 195 within the IP payload (e.g., a shim header) and/or within an options field of the IP header. MAC traffic prioritization module 140 may then provide the packet, or frame containing the packet, to NAT module 130, which may impart a public IP address and port number associated with MAC traffic prioritization module 140 to the packet. WAN interface module 120 may then transmit a frame comprising the IP packet over the WAN. For instance, the WAN interface module 120 and/or PHY 125 may include its own MAC address as a source MAC address in a frame header, and a MAC address of a next-hop router (e.g., a provider edge (PE) router or the like) as a destination MAC address.

It should be noted that the example of FIG. 1 illustrates that the non-priority path 185 does not include the MAC traffic prioritization module 140. However, in one example, the wireless access point 100 may be configured such that all data traffic may pass to MAC traffic prioritization module 140, which may perform an initial screening to extract data traffic that it is intended to process, and which may immediately pass other data traffic to the non-priority path 185 when it is determined that such frames/packets are not designated for differentiated processing via the wireless access point 100.

In addition to enabling MAC-based routing to endpoint devices behind the wireless access point 100 from external entities, differentiated processing via wireless access point 100 may also include allocating to priority path 180 a priority processing queue for designated MAC addresses. For instance, for outbound packets, NAT module 130 may include or may be associated with two or more queues from which NAT module 130 may draw packets/frames for NAT processing. For example, a first queue may be for packets/frames from priority path 180 and MAC traffic prioritization module 140, while one or more other queues may be for packets/frames from non-priority path 185. Packets/frames may be drawn from the priority queue ahead of packets/frames in the non-priority queue, or may be drawn with a greater frequency or likelihood than packets/frames from the non-priority queue(s). Similarly, for inbound packets, differentiated processing via wireless access point 100 may also include allocating to priority path 180 a priority processing queue at radio unit 110 for designated MAC addresses, and one or more non-priority queues for other data traffic. In one example, this may be accomplished by MAC traffic prioritization module 140 applying a first quality of service (QoS) tag to a frame header, where the first QoS tag indicates a higher transmission priority for a packet (or frame containing the packet) as compared to packets/frames that do not include the first QoS tag (or e.g., containing a second lower priority QoS tag). For instance, these other packets/frames may include a different QoS tag that indicates a lower priority, or no QoS tag. Then, at the radio unit 110, frames/packets with the first QoS tag may be transmitted before frames/packets without the first QoS tag, or with a greater frequency or likelihood as compared to frames/packets without QoS tags, or with other lower priority QoS tags.

It should be noted that although the term “non-priority” is used herein, this does not mean that packets/frames on non-priority path 185 or in a non-priority queue have no priority. Rather, the relative term “non-priority” is used merely in reference to the data traffic for designated MAC addresses, which have differentiated processing (e.g., including priority and/or reduced latency, etc.) as described herein. In other words, among the packets/frames being processed via non-priority path 185, there may be further varying levels of priority, QoS/CoS, or the like. For instance, packets/frames that may be identified as video conference data traffic may have a higher QoS tag compared to packets/frames for email, document downloading/uploading, document printing, and so forth.

MAC traffic prioritization module 140 may also provide MAC address-based differentiated processing for data traffic associated with two or more designated MAC addresses on the local network (associated with the SSID of the wireless access point 100). For example, two users may be at a premises (e.g., a home) connected to the wireless access point 100 and playing the same AR/VR game, which may have challenging latency demands. In one example, to reduce latency, MAC traffic prioritization module 140 may receive instructions from a game server that all or a portion of the gaming traffic for both devices should be hair-pinned locally without reaching the server over the WAN via NAT. In one example, the endpoint devices may permit the data traffic to be hair-pinned without encryption, thereby further reducing latency. The ability to divert packets/frames to MAC traffic prioritization module 140 based on the MAC addresses of the endpoint devices permits the MAC traffic prioritization module 140 to apply additional logic to determine whether and when to avoid unnecessary transmissions of data over the WAN to the gaming server.

Alternatively, or in addition, two endpoint devices engaged in the same game may connect to a game server with a single consolidated stream from MAC traffic prioritization module 140, e.g., for at least part of the game content. For instance, maps, movements of other objects within the game, music, etc. may be the same for both endpoint devices. As such, the game server may transmit a single stream for this shared content for both endpoint devices to MAC traffic prioritization module 140. In one example, MAC traffic prioritization module 140 may select one MAC address to use in connection with accessing the external content. In another example, the game server may provide instructions to designate one or the other MAC address.

In one example, for inbound game content, MAC addresses for both endpoint devices may be included in the IP packet payload or options field of the IP header to identify that the packet(s)/frame(s) are for both endpoint devices.

MAC traffic prioritization module 140 may then copy (e.g., duplicate) and forward packets/frames to both endpoint devices via priority path 180. In one example, other bidirectional traffic may still be hair-pinned locally for the endpoint devices by MAC traffic prioritization module 140. For example, if the two players are playing as a team and have a shared audio session that does not include other players, this two-way audio session may be maintained locally via wireless access point 100. In other words, in-game voice communication just between teammates and local endpoint devices may be routed locally by wireless access point 100, but other game traffic may traverse the WAN between wireless access point 100 and the game server. It should be noted that in accordance with the present disclosure, the gaming server may remain aware of the MAC addresses of the respective endpoint devices participating in the game. As such, the gaming server may authorize MAC traffic prioritization module 140 to be permitted to aggregate requests for devices when appropriate, may grant permission to hairpin traffic locally where appropriate, and so forth. In one example, the game server may provide configurations/instructions to MAC traffic prioritization module 140 to know which type of traffic that it is permitted to hairpin, which type of traffic that it is allowed to aggregate into single stream for uplink or downlink, and so forth (e.g., two-way voice/audio stream, background scenery, locally selected music, and so on). In one example, two endpoint devices in an AR/VR game may have slight differences in game view (e.g., different viewports with different tiles in view). However, there may be significant overlap in the overall game view(s). Some is pre-cached, some is live, and so on. In one example, MAC traffic prioritization module 140 may also be configured to determine the overlaps and reduce requests to the server for viewable content, music, etc. Thus, the MAC traffic prioritization module 140 can utilize two streams when appropriate (e.g., when the respective endpoints have unique game data), or can elect to sometimes use one stream, even within same game session.

It should be noted that FIG. 1 illustrates just one example of a wireless access point 100 (e.g., a Wi-Fi access point) in accordance with the present disclosure. Accordingly, it should be understood that other, further, and different examples may include more or less components, may have components installed in a different configuration, layout, arrangement, and/or design, and so forth. For instance, in another example, wireless access point 100 may include additional slots for additional WAN interface modules, or wired local area network (LAN) interface modules (e.g., with RJ-45 Ethernet connections, or the like). In one example, wireless access point may further include a memory, e.g., to store MAC filter rules, NAT mappings, MAC traffic prioritization authorizations, and other instructions, code, logic, etc. to enable various functionality. In one example, MAC filter module 150, NAT module 130, and MAC prioritization module 140 may comprise dedicated processes executed by a processing system including one or more processor elements (e.g., central processing unit (CPU) cores, or the like). Alternatively, or in addition, any one or more of MAC filter module 150, NAT module 130, and MAC prioritization module 140 may comprise dedicated hardware, such as an ASIC or FPGA configured/programmed to provide the above-described functionality. Accordingly, the connections between MAC filter module 150, NAT module 130, and MAC prioritization module 140 may comprise one or more internal busses/interfaces (e.g., traces, vias, wiring, etc.) which enable communication (including packet/frame forwarding) in accordance with a peripheral component interconnect (PCI) protocol, such as PCI express (PCIe), a serial peripheral interface (SPI) protocol, an internal Ethernet bus, or the like. In one example, the connection(s) may comprise a media independent interface (MII), such as a gigabit media independent interface (GMII), a serial gigabit media independent interface (SGMII), a quad serial gigabit media independent interface (QSGMII), a 10-gigabit media independent interface (XGMII), a universal serial gigabit media independent interface (USGMII), or the like, e.g., with backwards compatibility and/or cross-compatibility with multiple MII types, and so forth. In one example, the wireless access point 100 may further include a power supply unit, a storage unit (e.g., non-volatile solid state drive (SDD), a non-volatile memory express (NVME or NVMe) module, a secure digital (SD) extreme capacity (SDXC) module, a SD ultra-capacity (UC) module, or the like), and other components.

Thus, these and other extensions are all contemplated within the scope of the present disclosure.

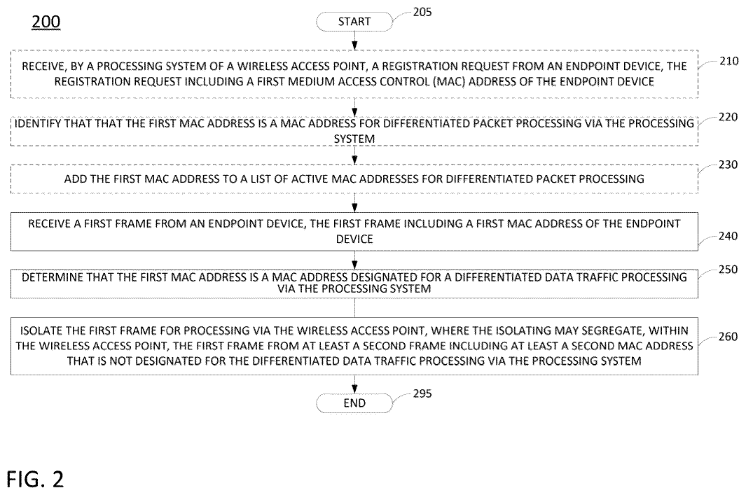

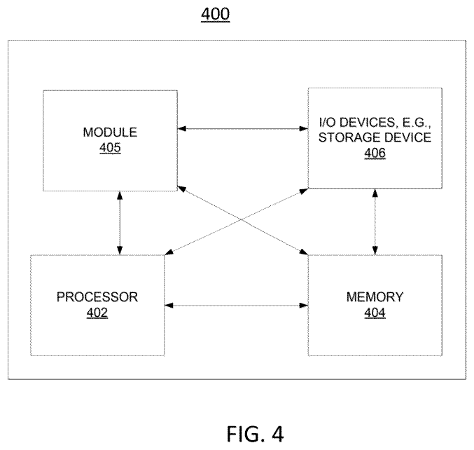

FIG. 2 illustrates a flowchart of an example method 200 for isolating a first frame for processing via a wireless access point in response to determining that a first medium access control address of the first frame is a medium access control address for differentiated data traffic processing. In one example, the steps, functions, or operations of method 200 may relate to or be performed by or in connection with a wireless access point and/or a MAC traffic prioritization module thereof, such as described in connection with FIG. 1, or the like. In one example, the steps, functions, or operations of method 200 may be performed by a computing device or system 400, and/or a processing system 402 as described in connection with FIG. 4 below. For instance, the computing device 400 may represent at least a portion of a wireless access point in accordance with the present disclosure. For illustrative purposes, the method 200 is described in greater detail below in connection with an example performed by a processing system, such as processing system 402. The method 200 begins at step 205 and may proceed to optional step 210 or to step 240.

At optional step 210, the processing system, e.g., of a wireless access point, may receive a registration request from an endpoint device, where the registration request includes a first medium access control (MAC) address (e.g., of the endpoint device). In one example, the processing system may comprise a hardware module of the wireless access point that is situated between a MAC filter module of the wireless access point and a network address translation (NAT) module of the wireless access point, and that is in communication with the MAC filter module and the NAT module (e.g., via one or more busses comprising one or more of traces, vias, wires/cables, fibers, etc.).

At optional step 220, the processing system may identify that the first MAC address is a MAC address designated for differentiated packet processing via the processing system. For instance, the processing system may be configured with a list of endpoint devices (e.g., identified by the MAC addresses thereof) that are authorized or designated (e.g., if the endpoint device and the wireless access point were initially purchased as a bundle) to receive differentiated MAC address-based handling via the processing system.

At optional step 230, the processing system may add the first MAC address to a list of active MAC addresses for differentiated packet processing. For instance, the processing system may commence active filtering/scanning for packets/frames containing the first MAC address.

At step 240, the processing system receives a first frame from an endpoint device, the first frame including a first MAC address of the endpoint device. As discussed above, the first frame may encapsulate an Internet Protocol (IP) packet. For instance, the IP packet may include a private IP address of the endpoint device as a source IP address.

At step 250, the processing system determines that the first MAC address is a MAC address designated for differentiated data traffic processing via the processing system. In one example, the determining that the first MAC address is a MAC address authorized or designated for differentiated data traffic processing may be in accordance with a list of active MAC addresses described at optional step 230.

At step 260, the processing system isolates the first frame for processing via the wireless access point. For instance, the isolating may segregate, within the wireless access point, the first frame from at least a second frame including at least a second MAC address that is not designated for the differentiated data traffic processing via the processing system. In one example, the isolating may include forwarding the first frame via a priority queue of the wireless access point that is reserved for frames with MAC addresses that are designated for differentiated data traffic processing via the processing system. On the other hand, the at least the second frame may be forwarded via a non-priority queue. In one example, the priority queue has a reduced latency metric as compared to the non-priority queue. For example, frames (or packets thereof) may be drawn from the priority queue ahead of frames/packets in the non-priority queue, or may be drawn with a greater frequency or likelihood than frames/packets from the non-priority queue(s). In one example, the forwarding may be to a network address translation (NAT) module of the wireless access point for transmission over a wide area network (WAN). In one example, the isolating may include transmitting the first frame (e.g., as an Ethernet frame) via the NAT module and a WAN interface module.

In one example, the processing system may be assigned an internal IP address (or private IP address). In one example, a source IP address of a first packet of the first frame may comprise the internal IP address (when forwarded to the NAT module). In addition, the NAT module may be configured to replace the source IP address of the first packet with a public IP address that is different from the internal/private IP address. In addition, in one example, the NAT module may also change a source port number. In another example, the isolating of step 260 may comprise detecting that a destination IP address (or combination of destination IP address and destination port number) of the first frame is associated with a second endpoint device within a local network of the wireless access point. In such case, in response to the detecting, the processing system may then divert the first frame to the second endpoint device (e.g., a local hairpin that does not traverse the WAN). In one example, this may include detecting that the destination IP address of the first packet of the first frame is a public/external IP address that is associated with the local network and that the port identifies a particular endpoint device on the local network. In one example, the endpoint device identified by public/external IP and port could be the processing system (e.g., a component of a wireless access point that may be performing the method, such as a MAC traffic prioritization module). Following step 260, the method 200 proceeds to step 295 where the method 200 ends.

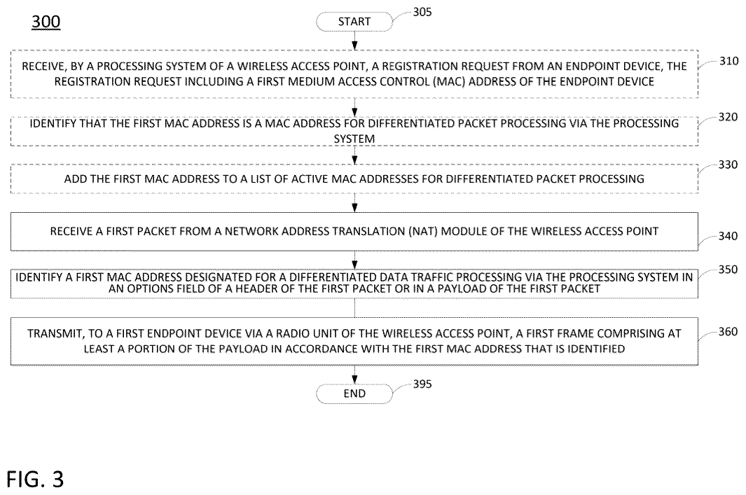

It should be noted that the method 200 may be expanded to include additional steps or may be modified to include additional operations with respect to the steps outlined above. For example, the method 200 may be repeated for additional frame/packets from the first endpoint device (e.g., repeating steps 240-260), may be repeated for new authorized endpoint devices (e.g., repeating steps 210-260), and so forth. In one example, the method 200 may be expanded or modified to include steps, functions, and/or operations, or other features described in connection with the example(s) of FIG. 1 and/or FIG. 3, or as described elsewhere herein. Thus, these and other modifications are all contemplated within the scope of the present disclosure.

FIG. 3 illustrates a flowchart of an example method 300 for transmitting a first frame comprising at least a portion of a payload of a packet that is received from a network address translation module in accordance with a first medium access control address that is identified in the payload of the packet. In one example, the steps, functions, or operations of method 300 may relate to or be performed by or in connection with a wireless access point and/or a MAC traffic prioritization module thereof, such as described in connection with FIG. 1, or the like. In one example, the steps, functions, or operations of method 300 may be performed by a computing device or system 400, and/or a processing system 402 as described in connection with FIG. 4 below. For instance, the computing device 400 may represent at least a portion of a wireless access point in accordance with the present disclosure. For illustrative purposes, the method 300 is described in greater detail below in connection with an example performed by a processing system, such as processing system 402. The method 300 begins at step 305 and may proceed to optional step 310 or to step 340.

At optional step 310, the processing system, e.g., of a wireless access point, may receive a registration request from an endpoint device, where the registration request includes the first medium access control (MAC) address. In one example, the processing system may comprise a hardware module of the wireless access point that is situated between a MAC filter module of the wireless access point and a network address translation (NAT) module of the wireless access point, and that is in communication with the MAC filter module and the NAT module.

At optional step 320, the processing system may identify that that the first MAC address is a MAC address designated for differentiated packet processing via the processing system. For instance, the processing system may be configured with a list of endpoint devices authorized or designated to receive differentiated MAC address-based handling via the processing system.

At optional step 330, the processing system may add the first MAC address to a list of active MAC addresses designated for differentiated packet processing. For instance, the processing system may commence active filtering/scanning for packets/frames containing the first MAC address.

At step 340, the processing system receives a first packet from the NAT module of the wireless access point. For example, the first packet may be received by the NAT module comprising a first destination IP address and a first destination port. The NAT module may then replace the first destination IP address with a second destination IP address comprising an internal IP address that is assigned to the processing system (e.g., internal/private to the local wireless network provided via the wireless access point). The NAT module may optionally replace/modify the destination port number as well, depending on the configuration of the NAT. In one example, the first packet is initially received by the wireless access point via a wide area network (WAN) interface (e.g., from an Ethernet PHY of the wireless access point or the like) and may be passed to the NAT module. In one example, the first packet may be encapsulated in a first Ethernet frame when received via the WAN interface. In one example, the first packet may be received from a server of a network operator, where the network operator may maintain a list of MAC addresses that are authorized for differentiated processing. Accordingly, in one example, a first MAC address may be included in a payload of the first by the network operator to indicate to the processing system a destination endpoint device behind the wireless access point. In one example, the NAT module may execute a filtering rule to permit the first packet to pass to the processing system when a source IP address and a source port of the first packet are designated according to the filtering rule.

At step 350, the processing system identifies a first MAC address designated for a differentiated data traffic processing via the processing system in an options field of a header of the first packet or in a payload of the first packet. In one example, step 350 may include determining that the first MAC address is a MAC address designated for differentiated data traffic processing via the processing system. In one example, the determining that the first MAC address is a MAC address designated for differentiated data traffic processing may be in accordance with a list of active MAC addresses described at optional step 330. In one example, the first MAC address may be included in an Options field of the IP header of the packet from which the processing system may identify the MAC address. In another example, the first MAC address may be embedded in a payload of the packet. In such case, the processing system may decrypt a payload of the first packet and identify the first MAC address within the payload (e.g., a shim header, or the like). For instance, the Options field may include an encrypted version of the MAC address that is indecipherable without the proper decryption key (and similarly for an example in which the MAC address is embedded within an encrypted payload of the first packet).

At step 360, the processing system transmits, to a first endpoint device via a radio unit of the wireless access point, a first frame comprising at least a portion of the payload in accordance with the first MAC address that is identified. In one example, step 360 may include forwarding the frame to the radio unit via a MAC filter module. In one example, the MAC filter module may be configured to pass the frame to the radio unit when the first MAC address contained in the frame is authorized in accordance with at least one rule of a rule set of the MAC filter module. In one example, step 360 may include applying a first QoS tag to a frame header, where the first QoS tag indicates a higher transmission priority for the first packet as compared to at least a second packet that does not include the first QoS tag. In one example, the first frame may comprise a Wi-Fi frame (e.g., in accordance with IEEE 802.11, or the like). For instance, the first frame may encapsulate the first packet (e.g., an IP packet). In addition, the first packet may include a private IP address of the endpoint device as a destination IP address (e.g., which may be added and/or substituted by the NAT module). Following step 360, the method 300 proceeds to step 395 where the method 300 ends.

It should be noted that the method 300 may be expanded to include additional steps or may be modified to include additional operations with respect to the steps outlined above. For example, the method 300 may be repeated for additional packets received for the first endpoint device (e.g., repeating steps 340-360), may be repeated for new authorized endpoint devices (e.g., repeating steps 310-360), and so forth. In one example, the method 300 may include the processing system communicating to a server of a network operator, a gaming server, or the like to indicate a designated public IP address and port for the processing system. Then if an inbound packet is addressed to the processing system by external/public IP and port, but the source IP and source port are not valid, the NAT module may prevent the packet from being passed to the processing system. Instead, it may discard the packet, or store the packet in a sandbox/quarantine for later inspection, for correlation with other packets that are suspicious (e.g., other packets that may fail an NAT filtering rule), etc. In one example, the method 300 may be expanded or modified to include steps, functions, and/or operations, or other features described in connection with the example(s) of FIG. 1 and/or FIG. 2, or as described elsewhere herein. Thus, these and other modifications are all contemplated within the scope of the present disclosure.

In addition, although not expressly specified above, one or more steps of the example method 200 or the example method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 and/or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

In addition, it should be noted that in one example, steps, functions, and/or operations of the method 200 of FIG. 2 or the method 300 of FIG. 3 may be performed by a wireless access point such as illustrated in FIG. 1 and described above. For instance, a wireless access point, of the present disclosure may include a NAT module, a MAC filter module, a radio unit, a WAN interface module, and a MAC traffic prioritization module situated between the MAC filter module and the NAT module of the wireless access point, and that is in communication with the MAC filter module and the NAT module. In one example, the MAC traffic prioritization module may be configured to receive a first packet from the NAT module, identify a first MAC address in an options field of a header of the first packet or in a payload of the first packet, and transmit to a first endpoint device via the MAC filter module and the radio unit, a first frame comprising at least a portion of the payload in accordance with the first MAC address that is identified. Alternatively, or in addition, the MAC traffic prioritization module may be configured to receive a first frame from an endpoint device, the first frame including a first MAC address of the endpoint device, determine that the first MAC address is a MAC address for differentiated data traffic processing via the processing system, and isolate the first frame for processing via the wireless access point, wherein the isolating segregates, within the wireless access point, the first frame from at least a second frame including at least a second MAC address that is not designated for the differentiated data traffic processing via the processing system.

FIG. 4 depicts a high-level block diagram of a computing device or processing system 400 specifically programmed to perform functions described herein, e.g., of a wireless access point and/or a MAC traffic prioritization module thereof, etc. For example, the processing system 400 of FIG. 4 may represent a wireless access point 100 as illustrated in FIG. 1 or described in connection with the above method(s). As depicted in FIG. 4, the processing system 400 comprises one or more hardware processor elements 402 (e.g., a microprocessor, a central processing unit (CPU) and the like). For instance, the one or more hardware processor elements 402 may represent an MAC traffic prioritization module that is a component of a wireless access point. Processing system 400 may further include a memory 404, (e.g., random access memory (RAM), read only memory (ROM), a disk drive, an optical drive, a magnetic drive, and/or a Universal Serial Bus (USB) drive), etc. For instance, memory 404 may represent a memory component of a MAC traffic prioritization module of the present disclosure and/or may represent a memory component mounted elsewhere within the wireless access point that is external to the MAC traffic prioritization module (but that is accessible to the MAC traffic prioritization module). Module 405 may represent instructions, code, configuration values/settings, and so forth to implement functions of a wireless access point and/or a MAC traffic prioritization module thereof, e.g., including the steps, functions, and/or operations of the example method 200 of FIG. 2 and/or the example method 300 of FIG. 3. In one example, all or a portion of module 405 may be stored in a storage device of the processing system (e.g., mounted to a baseboard and or accessible via USB, PCIe, serial bus interface (SBI), etc.) and/or loaded into memory 404 for execution by hardware processor element(s) 402. Processing system 400 may further include various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). For instance, input/output devices 406 may represent network interface modules as described herein, e.g., SFP, SFP+, or the like, as well as radio unit (e.g., in accordance with IEEE 802.11/Wi-Fi).

Although only one processor element is shown, it should be noted that the computing device may employ a plurality of processor elements. It should be noted that functions of a wireless access point and/or MAC traffic prioritization module of the present disclosure can be implemented in software and/or in a combination of software and hardware, such as one or more application specific integrated circuits (ASICs), programmable logic arrays (PLAs), including field-programmable gate arrays (FPGAs), or a state machine deployed on a hardware device, a computing device, or any other hardware equivalents, e.g., computer readable instructions pertaining to the specific wireless access point and/or MAC traffic prioritization module operations can be used to configure/program the hardware processor element(s) 402.

In one example, instructions and data for the present module or process 405 (e.g., a software program comprising computer-executable instructions) can be loaded into memory 404 and executed by hardware processor element(s) 402 to implement the specific wireless access point and/or MAC traffic prioritization module functions intended for the processing system 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the specific wireless access point and/or MAC traffic prioritization module functions can be perceived as a programmed processor or a specialized processor. As such, the present module 405 (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
receiving, by a processing system including at least one processor of a wireless access point, a first frame from an endpoint device, the first frame including a first medium access control address of the endpoint device;
determining, by the processing system, that the first medium access control address is a medium access control address designated for a differentiated data traffic processing via the processing system; and
isolating, by the processing system, the first frame for processing via the wireless access point, wherein the isolating segregates, within the wireless access point, the first frame from at least a second frame including at least a second medium access control address that is not designated for the differentiated data traffic processing via the processing system.

2. The method of claim 1, wherein the isolating comprises forwarding the first frame via a priority queue of the wireless access point that is reserved for frames with medium access control addresses that are designated for the differentiated data traffic processing via the processing system.

3. The method of claim 2, wherein the at least the second frame is forwarded via a non-priority queue.

4. The method of claim 3, wherein the priority queue has a reduced latency metric as compared to the non-priority queue.

5. The method of claim 2, wherein the forwarding is to a network address translation module of the wireless access point for transmission over a wide area network.

6. The method of claim 5, wherein the processing system is assigned an internal internet protocol address, wherein a source internet protocol address of a first packet of the first frame comprises the internal internet protocol address and wherein the network address translation module is configured to replace the source internet protocol address of the first packet with a public internet protocol address that is different from the internal internet protocol address.

7. The method of claim 1, wherein the isolating comprises:
detecting that a destination address of the first frame is a second endpoint device within a local network of the wireless access point; and
diverting the first frame to the second endpoint device.

8. The method of claim 1, wherein the processing system comprises a hardware module of the wireless access point that is situated between a medium access control filter module of the wireless access point and a network address translation module of the wireless access point, and that is in communication with the medium access control filter module and the network address translation module.

9. The method of claim 1, further comprising:
receiving a registration request from the endpoint device, wherein the registration request includes the first medium access control address;
identifying that the first medium access control address is a medium access control address designated for the differentiated packet processing via the processing system; and
adding the first medium access control address to a list of active medium access control addresses designated for the differentiated packet processing, wherein the determining that the first medium access control address is a medium access control address designated for the differentiated data traffic processing is in accordance with the list of active medium access control addresses.

10. An apparatus comprising:
a processing system including at least one processor of a wireless access point; and
a computer-readable medium storing instructions which, when executed by the processing system, cause the processing system to perform operations, the operations comprising:
receiving a first frame from an endpoint device, the first frame including a first medium access control address of the endpoint device;
determining that the first medium access control address is a medium access control address designated for a differentiated data traffic processing via the processing system; and
isolating the first frame for processing via the wireless access point, wherein the isolating segregates, within the wireless access point, the first frame from at least a second frame including at least a second medium access control address that is not designated for the differentiated data traffic processing via the processing system.

11. A method comprising:
receiving, by a processing system of a wireless access point, a first packet from a network address translation module of the wireless access point;
identifying, by the processing system, a first medium access control address designated for a differentiated data traffic processing via the processing system in an options field of a header of the first packet or in a payload of the first packet; and
transmitting, by the processing system to a first endpoint device via a radio unit of the wireless access point, a first frame comprising at least a portion of the payload in accordance with the first medium access control address that is identified.

12. The method of claim 11, wherein the first frame comprises a wi-fi frame.

13. The method of claim 11, wherein the first packet is received by the network address translation module comprising a first destination internet protocol address and a first destination port, and wherein the network address translation module replaces the first destination internet protocol address with a second destination internet protocol address comprising an internal internet protocol address that is assigned to the processing system.

14. The method of claim 11, wherein the transmitting includes forwarding the first frame to the radio unit via a medium access control filter module.

15. The method of claim 11, wherein the transmitting includes applying a first quality of service tag to a frame header, wherein the first quality of service tag indicates a higher transmission priority for the first packet as compared to at least a second packet that does not include the first quality of service tag.

16. The method of claim 14, wherein the medium access control filter module is configured to pass the first frame to the radio unit when the first medium access control address contained in the first frame is authorized in accordance with at least one rule of a rule set of the medium access control filter module.

17. The method of claim 11, wherein the first packet is received by the wireless access point via a wide area network interface.

18. The method of claim 17, wherein the first packet is encapsulated in a first Ethernet frame when received via the wide area network interface.

19. The method of claim 17, wherein the first packet is received from a server of a network operator, wherein the network operator maintains a list of medium access control addresses that are authorized for differentiated processing.

20. The method of claim 19, wherein the network address translation module executes a filtering rule to permit the first packet to pass to the processing system when a source internet protocol address and a source port of the first packet are designated according to the filtering rule.
